(19) United States
(12) Patent Application Publication
(10) Pub. No.: US 2019/0213486 A1
(43) Pub. Date: Jul. 11, 2019

(54) Virtual Adaptive Learning of Financial Articles Utilizing Artificial Intelligence

(71) Applicants: Tiffany Quynh-Nhi Do, Cupertino, CA (US); Jacqueline Thanh-Thao Do, Cupertino, CA (US)

(72) Inventors: Tiffany Quynh-Nhi Do, Cupertino, CA (US); Jacqueline Thanh-Thao Do, Cupertino, CA (US)

(21) Appl. No.: 15/863,869

(22) Filed: Jan. 6, 2018

(51) Int. Cl. G06N 5/02; G06N 99/00

(52) U.S. Cl. CPC G06N 5/025; G06Q 40/00; G06N 99/005

(57) ABSTRACT

Build up a financial knowledge base by automated reading and analysis of financial articles. The knowledge base starts with a default set of financial keywords. The knowledge base is expanded on the financial keywords detected during the reading process. The Artificial Intelligence Virtual Adaptive Learning of Financial Articles Bot (“AI Financial Reader Bot”) simulates the processes of human adaptive learning through the expansion of its knowledge base via the keywords.

### SUMMARY

The Artificial Intelligence Financial Reader Bot (“AI Financial Reader Bot”) will read and process an entity's financial articles in its default knowledge base to identify key words, attributes, and values, which will expand the knowledge base. The AI Financial Reader Bot simulates human cognitive capabilities such as adaptive learning.

### DISCLOSURE

The present disclosure relates generally to the artificial intelligent method of simulating the adaptive learning processes of the human brain, while reading financial news as method sample.

### BACKGROUND

A default simple knowledge base of a certain business entity, is created when reading a financial article about such entity. During the reading process, financial key words are identified as additional data for the default knowledge base. Each keyword has a set of attributes associated with it. The AI Financial Reader Bot identifies these attributes and its value while reading the article. The default knowledge base is expanded when all keywords and its attributes are complete with the processing. The process of building the knowledge base may be called virtual adaptive learning of financial articles using AI.

### BRIEF DESCRIPTION OF THE DRAWINGS

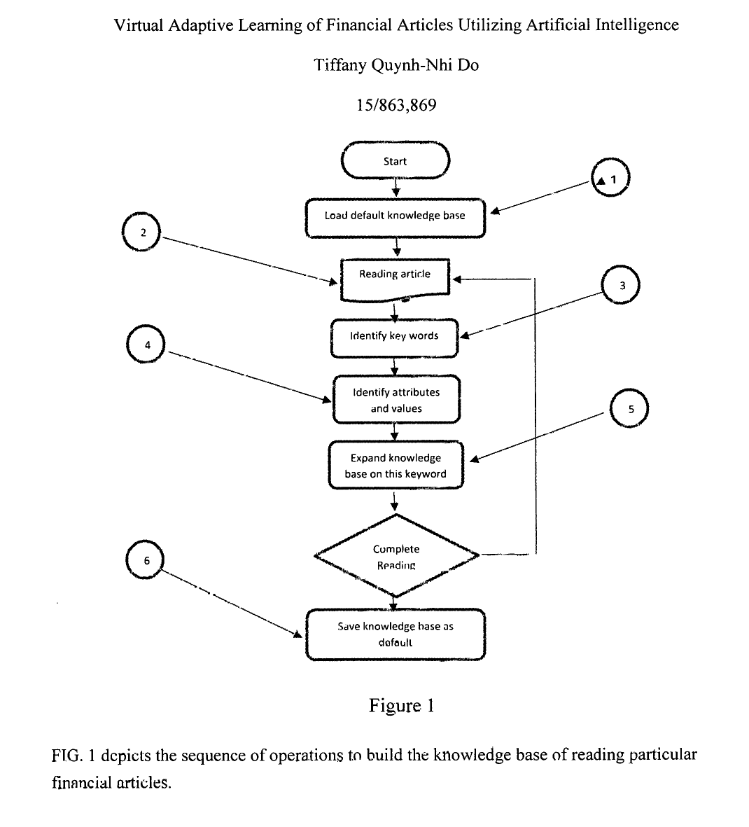

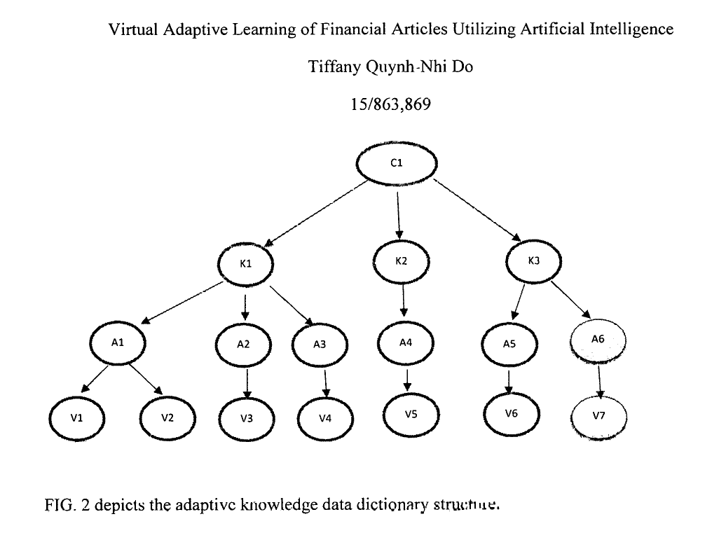

For a more complete understanding of the present disclosure and its features and advantages, reference is now made to the following description, taken in conjunction with the accompanying drawing in FIGS. 1 and 2:

### DESCRIPTION OF EXAMPLE EMBODIMENT

According to the embodiment, a financial article of any business entity could be read to expand the default financial knowledge base of the entity. Similar to human adaptive knowledge, the knowledge base is built based upon previous learning.

Certain embodiments of the disclosure may provide one or more technical advantages. A technical advantage of one embodiment may be that a financial decision could be made without human intervention. Another technical advantage of one embodiment may be that historical financial data of an entity can be drawn from the knowledge base after a period of reading time.

Certain embodiments of the disclosure may include none, some, or all of the above technical advantages. One or more other technical advantages may be readily apparent to one skilled in the art from the figures, descriptions, and claims included herein.

### DESCRIPTION

FIG. 1 depicts an example method to build the knowledge base of an entity. The steps of the method are described with regards to the elements of FIG. 1.

The method begins at step 1. At step 1, an entity's default knowledge base is retrieved from its central data base. A default knowledge base is the current financial state of this entity. At the initial state, the AI Financial Reader Bot has a set of generic keywords which are applied to all companies. Each keyword has a set of attributes with default values.

When it is ready to enter step 2, the AI Financial Reader Bot starts scanning the entity's financial articles to detect keywords in the knowledge base. Since the attributes involved with this keyword could be anywhere in the text, it bookmarks the location of the keywords detected and re-reads the article to collect all attributes.

In step 3, the article is re-read to scan relevant attributes associated with the keywords. A list of attributes will be found in the article after scanning the article. The learning data dictionary is presented in FIG. 2. It depicts how the data dictionary is used and updated. In general, each attribute has a set of values associated with it and these values are updated during the scanning process.

At step 4, if the value is found in the dictionary, this value is mapped to the attribute. If no value is found, the adaptive learning process kicks-in to add new value into the data dictionary.

The adaptive learning process is embodied in step 5, wherein which a value is compared with the rest of the values in the learning data dictionary. If the value is already located in the learning data dictionary, it is discarded. If it is not found in the learning data dictionary, the value is searched through a regular dictionary to find all its synonyms. If any synonym matches the current value, then the AI Financial Reader Bot will add this value to the learning data dictionary. Otherwise, a value is checked against the noise bucket; if the value is found with a different attribute, this value is declared as noise and is discarded. If a value is new to the noise bucket, it is added to the noise bucket.

The AI Financial Reader Bot method continues to search for the next keyword from the last bookmark until the complete article is read.

What is claimed is:

1) knowledge, default entity financial knowledge base is established as the foundation for reading entity financial articles action.

2) knowledge, entity financial knowledge base is expanded by acquiring adaptive data through keywords, attributes, and values

3) the method of claim 1, wherein determining how an entity financial knowledge base is built of default keywords, attributes and their associated values

4) the method of claim 2, wherein determining expansion of the entity financial knowledge base further comprising: determining, if the keyword belongs to the entity financial knowledge

5) The method of claim 2, further comprising: determining, if attributes belong to keyword

6) The method of claim 2, further comprising: determining, if value belongs to attribute

7) The method of claim 2, further comprising: determining, if value belongs to noise bucket and is dropped out
Modifications, additions, or omissions may be made to the systems, apparatuses, and methods disclosed herein without departing from the scope of the invention. The components of the systems may be integrated or separated. Moreover, the operations of the systems may be performed by more, fewer, or other components. Additionally, operations of the systems may be performed using any suitable logic comprising software, hardware, and/or other logic. The methods may include more, fewer, or other steps. Additionally, steps may be performed in any suitable order.
Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.
